(19) United States
(12) Patent Application Publication
(10) Pub. No.: US 2004/0175516 A1
(43) Pub. Date: Sep. 9, 2004

(54) Insulating arrangement for the inner insulation of an aircraft

(76) Inventors: Gerhard Schmitz, Hamburg (DE); Matthias Witschke, Hamburg (DE); Rainer Mueller, Rosengarten (DE); Petra Turanski, Suestedt (DE); Heiko Luetjens, Pinneberg (DE); Walter Kulcke, Jork (DE)

Correspondence Address: FASSE PATENT ATTORNEYS, P.A., P.O. BOX 726, HAMPDEN, ME, 04444-0726, US

(21) Appl. No.: 10/724,311

(22) Filed: Nov. 28, 2003

Related U.S. Application Data
(63) Continuation-in-part of application No. 09/830,625, filed on Apr. 27, 2001, now abandoned.
Application No. 09/830,625 is a 371 of international application No. PCT/DE99/03438, filed on Oct. 28, 1999.

(30) Foreign Application Priority Data
Oct. 28, 1998 (DE) 198 49 696.6

(51) Int. Cl. F16L 1/00

(52) U.S. Cl. 428/34.1

(57) ABSTRACT

An insulation arrangement includes an insulation packet that is made up of insulation material completely encased by a film, and that is arranged in an interspace between an inner trim component and an outer skin of an aircraft. The insulation packet does not completely fill the interspace, but rather leaves an air space. The film consists of a differentially gas permeable film material that provides a differentiated diffusion resistance with respect to water vapor diffusing therethrough, dependent on the direction of the diffusion through the film. Preferably the resistance to diffusion of water vapor into the insulation packet through the film is higher than the resistance to diffusion of water vapor out of the insulation packet through the film. The accumulation of moisture in the packet is avoided.

### CROSS-REFERENCE TO RELATED APPLICATION

This application is a Continuation-In-Part of U.S. application Ser. No. 09/830,625, filed on Apr. 27, 2001, which is the U.S. National Phase of PCT International Application PCT/DE99/03438 filed on Oct. 28, 1999.

### PRIORITY CLAIM

Through its above mentioned parent application, this application claims the priority under 35 U.S.C. §119 of German Application 198 49 696.6, filed on Oct. 28, 1998, the entire disclosure of which is incorporated herein by reference.

### FIELD OF THE INVENTION

The invention relates to an insulating arrangement for the inner insulation of an air vehicle.

### BACKGROUND OF THE INVENTION

It is known that the primary insulation located on the structure side for insulation systems presently used in aircraft construction essentially consists of an insulation core material and a film covering or encasing this insulation core material. The core material of the insulation system is protected against water entry with the conventionally utilized films. Moreover, the film covering or casing serves to secure the partially bulky or flossy insulation material. Generally, this film casing or covering is dimensioned so that it contributes the lowest possible weight to the overall insulation system.

In this context, due to the relatively thin film, water vapor diffuses through the film wall, and penetrates into the film-covered insulation packet. Thereby, the water vapor partially condenses in the insulation packet. Moreover, diffused liquid particles or water droplets repeatedly enter into the insulation packet through unsealed or leaky areas in the insulation packet or in the film covering. Due to the condensation in the insulation packet, the liquid particles or water droplets collect in the insulation material, and this accumulated water may only be removed by additional drying efforts. This also has a very unpleasant effect, namely that the insulation system gains in weight due to the water accumulation and thereby leads to an unnecessary increase of the weight of the aircraft.

### SUMMARY OF THE INVENTION

In view of the above, the invention is based on the object, to embody an insulation arrangement of the above mentioned type so that nearly no humid or moist air or other moist gas or water vapor or droplets will penetrate into the film-covered insulation packet and so that any moisture that does penetrate into the insulation packet shall quickly escape from the insulation packet without hindrance.

The above objects have been achieved according to one embodiment of the invention in an insulation packet comprising an insulation material completely surrounded and encased by a film that is selectively permeable to the diffusion of gases such as water vapor therethrough. Particularly, the film has a different diffusion resistance in an inward diffusion direction through the film into the packet, in comparison to an outward diffusion direction through the film out of the packet. Preferably, the film exhibits a higher diffusion resistance coefficient with respect to gas diffusion in the inward diffusion direction from outside of the packet to inside of the packet, and a lower diffusion resistance coefficient for gas diffusion in the outward diffusion direction from inside of the packet to outside of the packet. Such a film, in view of its differential directional diffusion or permeation characteristic, is called a “diode film” by the present inventors. The gas of interest with regard to the diffusion through the film is especially water vapor. Preferably, the “diode film” is impermeable by water vapor in the inward diffusion direction yet permeable by water vapor in the outward diffusion direction.

The above objects have further been achieved according to another embodiment of the invention, involving an insulation packet that comprises an insulation material that is surrounded and encased by a film casing made up of at least two different film sections on opposite sides of the insulation packet. A first film section on a first side of the insulation packet is permeable by water vapor, while a second film section on an opposite second side of the insulation packet is impermeable by water vapor. In this arrangement, each film section itself does not have to have a directionally differential water vapor diffusion or permeation characteristic, but the overall insulation packet has different water vapor permeation characteristics on the two opposite sides thereof, due to the two different permeation characteristics of the two different film sections.

The first side of the insulation packet covered by the first film section that is permeable by water vapor is preferably oriented outwardly toward the outer skin of an aircraft fuselage, in an installed condition of the insulation packet in the aircraft fuselage. On the other hand, the second side of the insulation packet covered with the second film section that is impermeable by water vapor is oriented inwardly toward the cabin interior, e.g. toward the inner trim paneling of the aircraft cabin, in the installed condition of the insulation packet in the aircraft fuselage. With this orientation of the insulation packet, the insulation packet “breathes” and can release water vapor on the side thereof oriented toward the cold outer skin of the aircraft, which is generally an environment having a lower water vapor content. On the other hand, the second side of the insulation packet, which faces the warm, relatively humid cabin interior of the aircraft, acts as a sealed film that is impermeable by water vapor, to prevent the penetration of highly moisture-loaded cabin interior air into the insulation packet. Alternatively, for other special applications, the insulation packet could be oriented in the opposite direction, namely with the “breathable” first film section oriented inwardly, and the sealed non-permeable second film section oriented outwardly, but such an orientation is not preferred for the installation of the insulation packet in the outer wall of an aircraft fuselage.

The above objects have still further been achieved according to the invention in another embodiment that combines features of the above mentioned embodiments. Namely, the above mentioned insulation packet is provided as an improved insulation packet of an insulation arrangement of an air vehicle, including an outer skin, an inner trim component that is spaced apart from the outer skin with an interspace therebetween, and the insulation packet arranged in the interspace. Preferably, the film of the insulation packet includes a first film section on an outer side of the packet facing toward the outer skin and a second film section on an inner side of the packet facing toward the inner trim component. The first film section provides a relatively lower diffusion resistance in a direction out of the packet toward the outer skin, while the second film section provides a relatively higher diffusion resistance in a direction from the inner trim component into the packet. These film sections can each comprise a respective “diode film” with a directionally differential diffusion characteristic as described above, or the first film section can comprise a simple water vapor permeable film while the second film section can comprise a simple water vapor impermeable film as also described above. In any event, all of the films preferably block the penetration of liquid water.

As a result of the above characteristic features of the invention, the film hinders the penetration of water vapor into the insulation packet, and preferentially allows any water vapor that does get inside the packet to diffuse out of the packet through the film.

The film or films used for the insulation packet according to the present invention can be embodied in various different ways. The so-called “diode film” that has different water vapor permeation characteristics in opposite directions through the film can be achieved as follows. First, such a film can have a varying porosity through the film-thickness thereof, with a greater porosity on the side of the film allowing a permeation or penetration of water vapor into and through the film, and a smaller or lower porosity on the side of the film that does not allow or hinders the permeation or penetration of water vapor into and through the film. Alternatively, such a “diode film” can comprise varying film materials through the thickness thereof. Such different or varying material compositions, in turn, can provide varying properties such as a varying hydrophilicity or hydrophobicity through the thickness of the film.

In general, the film materials can comprise amorphous, crystalline, or semi-crystalline polymers, such as, for example, 6-FDA-based polymers, polyimides (PI), polyetherimides (PEI) such as General Electric “Ultem”™, polystyrene (PS), polytetrafluoroethylene (PTFE), perfluorosulfonic acid resin membrane such as Du Pont “NAFION”™, polyethylene terephthalate (PET), silicone, or especially preferably poly(2,2-bistrifluoromethyl-4,5-difluoro-1,3-dioxole) (PDD)/(PTFE) such as Du Pont “AF 2400”™.

In both of the above cases, i.e. a varying porosity or a varying film material composition through the film thickness, this can be achieved with a single graded film, i.e. a single film layer. having a porosity gradient or a material composition gradient through a thickness thereof, or a multi-layered film, i.e. a film made up of plural successive layers that respectively have different porosities or different compositions. In the case of a multi-layered film, the several layers can be sandwiched and laminated together by any known process including adhesive bonding, thermal melt bonding or welding, multi-layer co-casting, etc. Alternatively, the several film layers can be left un-bonded or un-laminated to leave a small air gap between the successive layers, which will also have an influence on the transport of water vapor through the overall film.

In general, the water vapor transport through the films can occur through any one or more of the following processes: solution diffusion, capillary condensation, convective transport, multi-layer adsorption, Hagen-Poiseuille's flow, Knudsen flow, surface flow, and molecular sieving. These different transport processes by which water vapor can be transported through a given film can be tailored to achieve the desired permeation characteristics.

The differential diffusion permeability can further or alternatively be achieved by providing film materials with hydrophilic or hydrophobic properties as mentioned above. Namely, a hydrophilic film material will relatively easily take up water and allow the permeation of water vapor therethrough, while a hydrophobic film material will substantially block the permeation of water vapor therethrough. By providing a hydrophilic character on one surface and a hydrophobic character on the opposite surface of a film, this will allow a preferential water vapor permeation from the hydrophilic surface side toward the hydrophobic surface side, while substantially blocking water vapor permeation from the hydrophobic surface side toward the hydrophilic surface side.

The above described use of hydrophilic and hydrophobic characteristics can also be enhanced through a temperature-dependent nature of these characteristics. Namely, at low temperatures, the water vapor transport will be especially low, and will be made more difficult due to the hydrophobic character of the respective hydrophobic film material. On the other hand, as the temperature increases, the water vapor transport by means of the solution diffusion mechanism will be facilitated, especially through the film surface that has a hydrophilic character. Furthermore, film materials can be used that have a hydrophilic character at high temperatures and a hydrophobic character at low temperatures. With such a film, the water vapor diffusion through the film will be temperature-dependent, i.e. allowing a water vapor permeation especially at high temperatures, while blocking a water vapor permeation especially at low temperatures.

The film porosity can also be temperature-dependent, namely a film having essentially no pores or only very small pores at low temperatures, and larger pores at high temperatures. With such an arrangement, the film is essentially hydrophobic, and no water vapor can permeate through the small pores or no pores at low temperatures, while water vapor can permeate through the enlarged pores of the film at high temperatures with the material of the film matrix still being hydrophobic. It should be understood that liquid water cannot permeate through the porous film even at high temperatures when the porosity is increased.

The above considerations apply not only to the embodiments using a so-called “diode film”, but also to the embodiments of the invention using different film sections with different characteristics on the two opposite sides of an insulation packet. Namely, the first film section that is to allow water vapor diffusion (i.e. to have a relatively lower diffusion resistance) can be a film material with relatively high porosity, while the second film section that is to block water vapor permeation (i.e. having a relatively higher diffusion resistance) can be a film material with a relatively lower porosity. The first film section that preferentially allows water vapor permeation therethrough should be a porous hydrophobic film material, same as the second film section that preferentially blocks water vapor permeation therefrom being a dense film material.

Also as mentioned above, these characteristics can be temperature-dependent, so that the insulation packet has a temperature-dependent water vapor permeation or “breathing” characteristic. Namely, when the aircraft is flying at high altitude, and the insulation packet thereby becomes very cold, the water vapor transport through the film or films will be rather low. On the other hand, when the temperature of the insulation packet rises, e.g. when the aircraft is operating at lower altitudes or is on the ground, the water vapor diffusion through the dense film is facilitated.

A particular example of a combination of two different films involves a silicone film on the side of the insulation packet facing the outer aircraft skin, and a porous polytetrafluoroethylene (PDD)/(PTFE) film on the side of the insulation packet facing the interior aircraft cabin.

It is generally known in the art how to prepare a polymeric film having a desired composition, a desired porosity, and a desired hydrophilicity or hydrophobicity. It is also known in the art how to prepare such a film having a gradient of the porosity, composition, or hydrophilicity or hydrophobicity varying through the thickness thereof. This can be achieved in a single film layer or by a multi-layer film as described above. Any conventionally known techniques for forming films having such characteristics, and any conventionally known film materials, can be used for the present invention, as long as the film characteristics described herein are achieved.

### BRIEF DESCRIPTION OF THE DRAWINGS

In order that the invention may be clearly understood, it will now be described in greater detail in connection with example embodiments, with reference to the accompanying drawings, wherein:

FIG. 1 is a schematic sectional view of a conventional insulation arrangement in a wall of an aircraft, including an insulation packet arranged in an interspace between an inner trim component and an outer skin;

FIG. 2 is a schematic sectional view similar to FIG. 1, but showing the inventive insulation arrangement with an improved insulation packet including a selectively gas permeable film covering;

FIG. 3 is a schematic sectional diagram of another embodiment of a film-covered insulation packet according to the invention, graphically representing the directionally dependent gas diffusion resistance of the film that covers the packet;

FIG. 4 is a schematic sectional view of a multi-layer film for an insulation packet of the invention, wherein the film includes two layers having different porosities, which are laminated to each other;

FIG. 5 is a schematic sectional view of a multi-layer film including two layers having different porosities, which are not tightly laminated to each other but rather have an air gap therebetween;

FIG. 6 is a schematic sectional view of a multi-layer film including a hydrophobic layer and a hydrophilic layer laminated to each other;

FIGS. 7A and 7B are schematic sectional views illustrating a temperature-dependent porosity of a film;

FIGS. 8A to 8F are schematic sectional diagrams illustrating the principles of several transport mechanisms of water vapor or the like permeating through porous or microporous membranes; and

FIG. 9 is a diagram of volume (v) versus temperature (T), graphically demonstrating that the specific volume of the film or membrane material, and thus also the permeation transport through the membrane, increases with temperature.

### DETAILED DESCRIPTION OF PREFERRED EXAMPLE EMBODIMENTS OF THE INVENTION

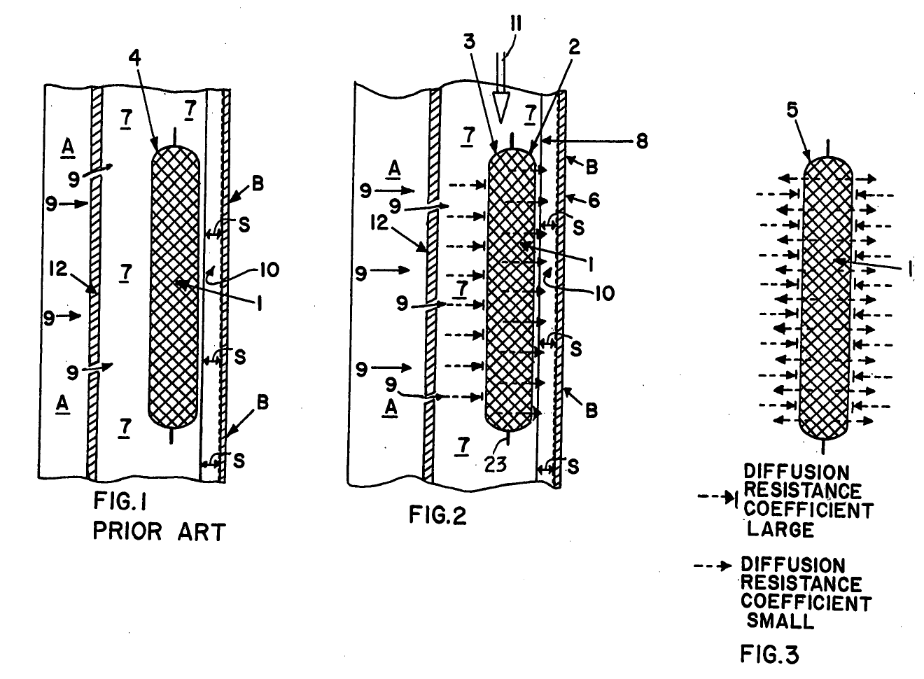

FIG. 1 illustrates a conventional insulation arrangement for an aircraft, installed in a known manner within an interspace (hollow space) which is bounded by the inner region A and the structure region B of the aircraft. In practice, the interspace 7 is formed between the metal outer skin 6 (allocated to the structure region B) and an inner trim component 12, for example a plate-like cabin trim panel arranged at a spacing from the outer skin 6. In this context, the inner trim component 12 largely follows the curvature of the outer skin 6, whereby a straight linear contour of both of these components is selected for simplicity in FIGS. 1 and 2. The inner trim component 12 is provided with machined-in slits or other holes or penetrations at certain locations, through which cabin air 9, which is generally relatively warm and has a relatively high moisture or humidity content, penetrates into the interspace 7. The actual insulation arrangement comprises an insulation packet 1 and a conventional film covering i.e. film 4 of synthetic plastic, which encases or covers the above mentioned bulky or flossy insulation material, or insulation material consisting of a foam, of the insulation packet 1, for the purpose of securing the same. An air gap s is formed between the insulation packet 1 and the outer skin 6.

The conventional insulation arrangement of known insulation systems, uses films 4 that largely prevent the entry of liquid water (entry of water, moist or humid air or other moisture), yet are not water vapor tight due to their low density or tightness or due to the low diffusion resistance coefficient of the film covering. This is especially disadvantageous on the film region or area directed toward the warmer cabin side of the insulation arrangement. The forward penetration of the relatively warm cabin air 9 through the slits and cut-out notches of the inner trim component 12 (cabin trim paneling) continues to the surface of the film 4. Thus, the air 9 loaded with a high moisture or humidity content can get into the insulation packet 1 through the film wall by an expected water vapor diffusion process.

During the cruise flight phase of the aircraft, a strong cooling of the outer skin 6 to approximately −50° C. will occur. Thus, it cannot be avoided, that the moisture contained in the water vapor condenses as the temperature drops below the dew point. The result will be a collecting or accumulating of moisture or ice in the insulation packet 1. During the landing and ground operation phase of the aircraft, the temperature of the outer skin 6 will increase. During this phase, the ice in the insulation packet 1 will correspondingly melt to become water in the insulation packet 1. The water will, however, only be able to leave or escape from the insulation packet 1 through larger (microporous) openings (not shown) in the film wall. It is disadvantageous, that therefore the possibility also exists, that water will once again enter into the insulation packet 1 through these film openings.

The release of water through the film wall in the form of water vapor is, however, only possible during a limited time, since the ground time of a commercial transport aircraft will generally be kept relatively short, and the conventional film 4 is not laid out for a more rapid release of water vapor out of the insulation packet 1. The above mentioned diffusion process will lead to an undesired accumulation of condensate water in the known insulation packets 1 that are encased or covered with a conventional film 4.

In the following, example embodiments of the invention will be described in greater detail with reference to FIGS. 2 and 3. For the sake of a better understanding, the insulation arrangement according to FIG. 3 will first be considered in greater detail. An insulation structure or arrangement is contemplated, which is made up of an insulation packet 1 and a film 5, which completely encases or covers the insulation packet 1, according to the example of FIG. 1. The installed arrangement of this insulation structure, which will similarly correspond to the arrangement according to FIG. 1, has been omitted from this schematic illustration. According to the two FIGS. 2 and 3, generally a film arrangement is contemplated, which is made up of a single film 5 encasing the insulation packet 1 (as in FIG. 3) or of two films or film sections 2, 3 that are joined or integrated with each other around a rim 23 so as to totally encase the insulation packet 1 (as in FIG. 2). Both film arrangements are generally realized with a gas-permeable film material having a different diffusion resistance characteristic dependent upon the diffusion direction of the total structure from the humid or damp inner space 7 to the cold outer skin 6.

With reference to FIG. 3, the differential diffusion resistance characteristic of the film 5 is achieved with a film material which provides a high diffusion resistance coefficient with respect to inward diffusion through the film from the film outer wall surface to the film inner wall surface, and provides a low diffusion resistance coefficient in the opposite diffusion direction (namely, from the film inner wall surface to the film outer wall surface). This film 5 is thus the above described “diode film” that may have a porosity gradient, a composition gradient, or a hydrophilicity gradient through a thickness thereof, or may have a temperature-dependent variable porosity or hydrophilicity, or may be a multi-layered film of film layers having different characteristics. Further details thereof will be described below in connection with FIGS. 4 to 9.

This above described film structure 5 is worth consideration, because one may therewith enclose or cover the outer surface area of the insulation packet 1 on all side areas with a single film consisting of the same film material, from the point of view of a rational fabrication of the insulation arrangement. This film 5 will function in such a manner, whereby the diffusion resistance coefficient is large in an inward diffusion direction through the film toward the internally located insulation packet 1 which is entirely covered or encased by the film 5. In other words, no water vapor can penetrate inwardly entirely to the insulation packet 1. The film 5 acts as a moisture blocker, i.e. a vapor barrier, in the inward diffusion direction. In the opposite outward diffusion direction, the film 5, however, has a different diffusion resistance coefficient, which is as small as possible, so that in the given case, the water accumulated inside the inwardly located insulation packet 1 can easily diffuse out of the insulation packet 1 in the form of water vapor.

Returning to FIG. 2, as mentioned, a film casing or covering is utilized, which is assembled or made up of two film sections or films 2, 3 of different types of materials. The two films 2, 3 are fixedly and seamlessly joined with each other along their film edges forming a joined rim 23, so that one obtains a complete enclosing film casing or cover. Furthermore, as already explained with regard to FIG. 1, the insulation arrangement according to the FIG. 2, with the film casing or cover made up of first and second films 2, 3, is likewise arranged within the mentioned interspace 7 enclosed by the inner trim component 12 (cabin trim paneling) and the metal outer skin 6 of the aircraft.

Thereby the insulation packet 1, which is fully covered or encased by the film made up of the two films 2, 3, will not completely line the interspace. Thereby the insulation arrangement will always be surrounded by a certain hollow air space, due to an intended supply of conditioned air 11 as will be described below.

This film casing that is formed by fusing or bonding the film edges of two films 2, 3 completely encloses the insulation packet 1 and lies thereon in such a manner so that the film surface of a first film 2 predominantly is arranged lying on the airframe stringer 8. The film surface of a second film 3 predominantly is positioned opposite the surface of the inner trim component 12 facing toward the inner space 7. The above descriptions say that the films are “predominantly” arranged as stated because certain edge regions or portions of the surface, that are limited to the section(s) of the fusion of both films 2, 3, are oriented in the direction of the lengthwise extension of the inner trim component 12 or of the stringer 8, and from there the above mentioned conditioned air 11 will also enter into the mentioned inner space 7.

Thereby the first film 2 will lie on the extended surface area of the stringer 8, thus in the selected example, not lying on the inner trim component 12. Since the second film 3 is located free in the inner region 7 and not lying on the inner trim component 12, the second film 3 will be surrounded most extensively by the conditioned air 11 that is provided by an air conditioning device of the aircraft and directed to flow through the inner region 7.

It is also mentioned at this point, that several spacer members are arranged between the outer skin 6 and the insulation packet 1, or between the stringer edge of the stringer 8 and the insulation packet 1. Hereby an air gap 10 with a gap spacing dimension s is formed between the film 2 and the outer skin 6.

The first film 2 consists of a film material that provides a low diffusion resistance coefficient especially in the diffusion direction of the gas diffusing through the film wall from the film inner wall surface to the film outer wall surface. The term gas is understood to mean, as mentioned previously, relatively warm air, which is loaded with high moisture or humidity in the form of water vapor, which flows through the slits and openings 9 of the inner trim component 12 into the inner region 7.

The second film 3 consists of a film material that provides a high diffusion resistance coefficient especially in the diffusion direction of the gas diffusing through the film wall from the film outer wall surface to the film inner wall surface.

According to all embodiments of the described insulation arrangement, the film-encased insulation packet 1 preferably comprises an insulation material consisting of polyphenylene sulfide (PPS), preferably in the form of a fleece of PPS fibers. The latter is covered or encased by the single “diode film” 5 embodied as a synthetic plastic film according to FIG. 3, or by the film arrangement consisting of two different types of films 2, 3, which may or may not each be “diode films”, and which are combined together to form thereof a single combined film according to FIG. 2. Thereby the film material(s) of the film provide(s) a differential diffusion resistance coefficient, depending on the direction of the diffusion occurring through the film wall, as described previously. Their spatial arrangement within the inner region or interspace 7 is adapted, at the location of their contact surface, to the surface contour of the inner surface of the stringer 8 (oriented toward the inner trim component 12) and to the surface contour of the inner surface of the outer skin 6.

Summarizing the above discussion, the different films 2, 3, 5 according to FIGS. 2 and 3 consist of different types of film materials, so as to prevent an accumulation of condensate water in the insulation packet 1 encased by the film. The second film 3 according to FIG. 2 facing toward the inner region A comprises a film material that provides a high diffusion resistance coefficient especially in the vapor diffusion direction from the film outer wall surface to the film inner wall surface (or in both directions through this film). That has the advantage that the air that is loaded with a relatively high moisture or humidity, which flows in through slits and openings from the inner region A (for example from the passenger cabin of an aircraft) into the interspace 7, cannot diffuse directly into the primary insulation. At the area of the insulation arrangement oriented toward the outer skin 6 as a component of the aircraft fuselage structure, the first film 2 according to FIG. 2 is open to diffusion and comprises a low diffusion resistance coefficient especially in the vapor diffusion direction from the film inner wall surface to the film outer wall surface (or in both directions through this film).

The above construction provides the advantage that liquid water, which might unexpectedly accumulate by condensation in the insulation packet 1, can escape from the insulation packet 1 as water vapor in a relatively unhindered manner and therewith quickly, primarily while the aircraft is on the ground at a warm temperature. Thereby the insulation packet 1 is dried. For this purpose it is a prerequisite that a sufficient air gap s exists between the outer skin 6 and the first film 2. The stringer 8, on which lies the primary insulation, thereby functions as a spacer member relative to the outer skin 6. Additional holder elements will serve to maintain, or to enlarge if necessary, the air gap region 10 between the outer skin 6 and the insulation arrangement, i.e. the film-encased insulation packet 1.

Thus, in comparison to the conventional aircraft insulation, two essential effects are achieved by the invention:

a) The water vapor, which can come from the inner region A (originating from the passenger cabin) into the interspace or inner region 7, is prevented from penetrating, i.e. diffusing into the insulation packet 1 by the second film 3 functioning as a vapor barrier.

b) The liquid water, which nonetheless collects in the insulation packet 1, may, for example, leave the insulation packet 1 in the form of water vapor through the diffusionally open first film 2, during the warm ground phase of an aircraft. Thereby a drying of the primary insulation is supported, and therewith the accumulation of condensate water in the insulation system is prevented.

Both embodiments of the presented insulation arrangement according to FIGS. 2 and 3 provide the advantage of achieving an additional drying effect even during cruise flight of the aircraft with conditioned air, which is additionally supplied to the affected insulation arrangement by means of an active air conditioning device. This is especially because the film construction according to FIG. 3 will ensure that the insulation packet 1 can be dried out by the above discussed selective outward diffusion. Overall, the following advantages are achieved with the presented insulation constructions:

a) Less water vapor will enter into the insulation packet 1, so that also less condensation takes place in the insulation packet 1.

b) Condensate water, which has once collected in the insulation packet 1, can again escape from the insulation in the form of water vapor.

c) The insulation packet 1 can more easily be dried after all of the above.

d) Condensate water will no longer accumulate in the insulation packet 1.

e) Because less water is present in the insulation, the operating life of the insulation arrangement or system is increased.

f) Corresponding weight is saved in the air vehicle e.g. aircraft, whereby the flight capacity is increased.

g) The suggested measures may be carried out without special effort. That applies also to retrofitting air vehicles that are already in service.

h) If, nonetheless, a drying system is provided and used in the air vehicle, for drying the structure, then the described insulation arrangement according to FIGS. 2 and 3 may be installed to achieve an enhanced drying effectiveness.

FIG. 4 schematically shows a specific example of a film 5A to be used as a “diode film” 5 to cover the inventive insulation packet. The film 5A includes a first film layer 51 having a low porosity (i.e. a dense or microporous structure), and a second film layer 52 having a relatively higher porosity. The two layers 51 and 52 are bonded and tightly laminated together, for example by co-casting, co-extrusion, melt-bonding, etc. of the two layers. The layers may respectively consist of the same polymer material or different polymer materials.

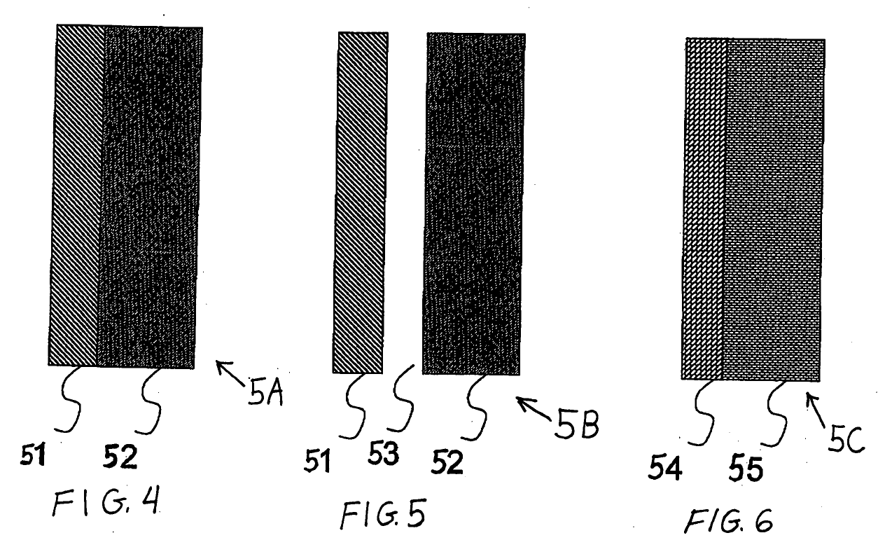

FIG. 5 schematically shows a specific example of a film 5B to be used as a “diode film” 5 to cover the inventive insulation packet. The film 5B includes a first film layer 51 having a low porosity (i.e. a dense or microporous structure), and a second film layer 52 having a relatively higher porosity. The two layers 51 and 52 are not bonded and tightly laminated together, but rather have an air space or gap 53 therebetween. This air space or gap 53 has a further influence on the overall permeation transport characteristic through the multi-layer film structure. The layers may respectively consist of the same polymer material or different polymer materials.

FIG. 6 schematically shows a specific example of a film 5C to be used as a “diode film” 5 to cover the inventive insulation packet. The film 5C includes a first film layer 54 having a hydrophilic character, and a second film layer 55 having a character that has a higher water permeability. The two layers 54 and 55 are bonded and tightly laminated together, for example by co-casting, co-extrusion, melt-bonding, etc. of the two layers. The layers may respectively consist of the same polymer material with different treatments or processing or preferably different polymer materials to achieve the different water permeation characteristics. The hydrophobic layer 55 is preferably oriented toward the environment with the higher moisture content, while the other layer 54 is preferably oriented toward the environment with the lower moisture content. In the insulation packet with the film 5C forming a casing that encloses the insulation material, the more permeable layer 54 is preferably arranged facing the insulation on the inner surface of the film casing, while the other layer 55 is preferably arranged facing away from the inner insulation on the outer surface of the film casing. The layers may be arranged with the water impermeable layer 55 facing toward the aircraft interior cabin, and the water impermeable layer 54 facing toward the aircraft outer skin.

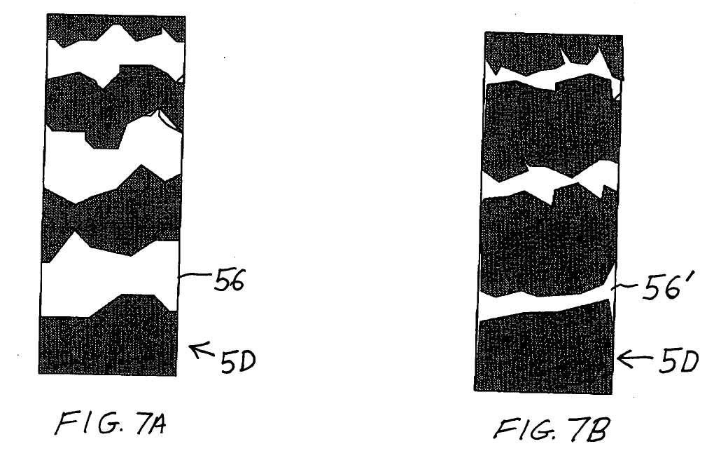

FIGS. 7A and 7B schematically illustrate a temperature-dependent porosity characteristic of a film 5D. FIG. 7A shows a porous film 5D with relatively large pores 56 at a higher temperature (e.g. +20° C.), while FIG. 7B shows the same film 5D at a lower temperature (e.g. −15° C.) at which the pores 56′ have shrunken, i.e. reduced in size, thereby reducing the effective porosity of the film 5D.

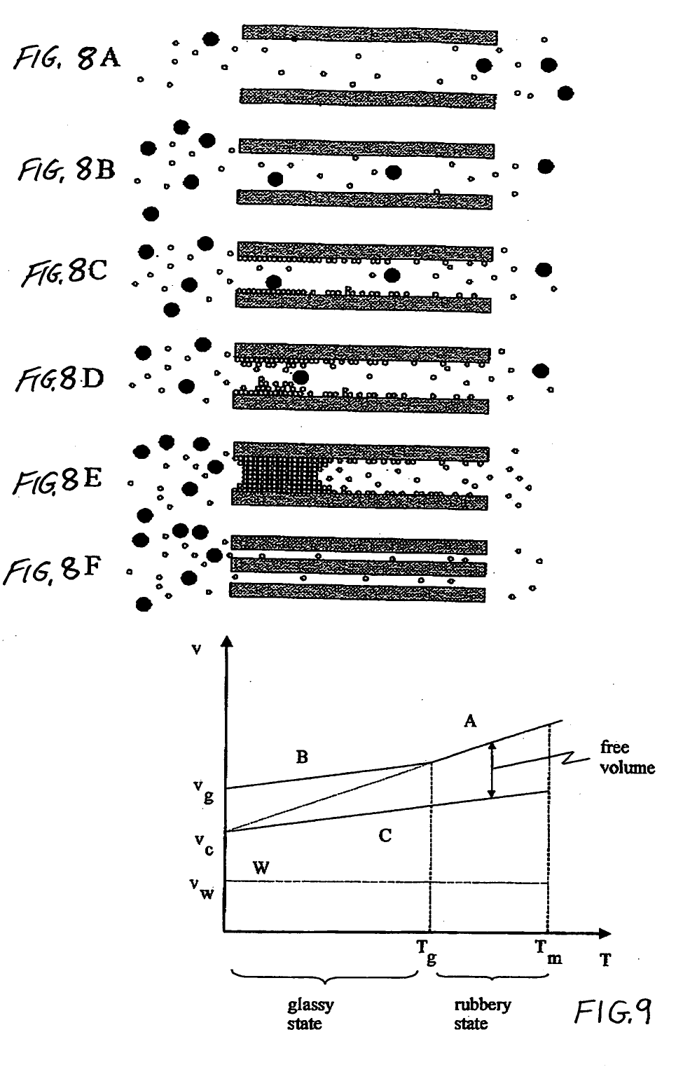

FIGS. 8A to 8F schematically illustrate several transport mechanisms relating to the permeation of water vapor in air or the like through a respective pore in a porous or microporous film. FIG. 8A represents Hagen-Poiseuille's flow. FIG. 8B represents Knudsen flow. FIG. 8C represents surface flow. FIG. 8D represents multi-layer adsorption. FIG. 8E represents capillary condensation. FIG. 8F represents molecular sieving.

The transport flow through a relatively dense membrane can be represented by the following equation:

$$J = \frac{\dot{n}}{A} = \frac{{P}_{e} ( {f}_{1} - {f}_{2} )}{l} \approx \frac{{P}_{e} ( {p}_{1} - {p}_{2} )}{l}$$

wherein:

J=flow or material flux through the membrane;

n=mole flow;

A=membrane surface area;

Pe=effective membrane permeability coefficient;

f1=upstream fugacity;

f2=downstream fugacity;

l=membrane thickness; and

p=pressure.

At low pressures, it can be assumed that f=p.

FIG. 9 diagrammatically shows that the specific volume of the membrane material, and thus also the material permeation transport therethrough, increases with increasing temperature. Specifically, the diagram shows the specific volume and the free volume as a function of temperature for an amorphous polymer: A is the specific volume of a liquid; B is the specific volume of a glassy polymer; C is the specific volume of a crystalline solid; W is the van der Waal's volume; Tg is the glass transition temperature; and Tm is the melting temperature.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An insulation packet comprising:
an insulation material; and
a directionally selectively permeable film completely surrounding and encasing said insulation material;
wherein said film has a directional diffusion characteristic comprising two different diffusion resistances with respect to water vapor diffusing through said film respectively in two opposite directions at a given location of said film.

2. The insulation packet according to claim 1, wherein said film has a varying porosity through a thickness thereof.

3. The insulation packet according to claim 1, wherein said film has a varying material composition through a thickness thereof.

4. The insulation packet according to claim 1, wherein said film has a varying hydrophilicity or hydrophobicity through a thickness thereof.

5. The insulation packet according to claim 1, wherein said film is a single-layer film that has a gradient of at least one of porosity, material composition, and hydrophilicity or hydrophobicity through a thickness thereof.

6. The insulation packet according to claim 1, wherein said film is a multi-layer film comprising plural layers that respectively have at least one of different porosities, different material compositions, and different hydrophilicities or hydrophobicities relative to each other.

7. The insulation packet according to claim 6, wherein said plural layers are laminated together to form said multi-layer film as a unitary multi-layer film without a gap between said layers.

8. The insulation packet according to claim 6, wherein said plural layers are not all laminated together and include at least one air gap therebetween.

9. The insulation packet according to claim 1, wherein said film has a temperature-dependent porosity, with a lower porosity at a lower temperature and a higher porosity at a higher temperature.

10. The insulation packet according to claim 1, wherein said film has a temperature-dependent hydrophilicity or hydrophobicity, with a more hydrophobic character at a lower temperature and a more hydrophilic character at a higher temperature.

11. The insulation packet according to claim 1, wherein said film comprises a polyetherimide.

12. The insulation packet according to claim 1, wherein said film comprises:
poly (2,2-bistrifluoromethyl-4,5-difluoro-1,3-dioxole) (PDD)/polytetrafluoroethylene (PTFE).

13. An insulation packet comprising:
an insulation material; and
a selectively permeable film completely surrounding and encasing said insulation material;
wherein said film has a first diffusion resistance with respect to water vapor diffusing through said film outwardly out of said insulation packet and a second diffusion resistance with respect to water vapor diffusing through said film inwardly into said insulation packet, and wherein said second diffusion resistance is greater than said first diffusion resistance.

14. The insulation packet according to claim 13, wherein said film has both said first diffusion resistance and said second diffusion resistance uniformly at all locations on said film.

15. The insulation packet according to claim 13, wherein said packet has two opposite major surfaces formed by said film, and wherein said film has both said first diffusion resistance and said second diffusion resistance uniformly at all locations on both of said two opposite major surfaces.

16. The insulation packet according to claim 13, wherein said film includes a first film portion and a second film portion respectively provided at two opposite major surfaces of said packet, said first film portion has said first diffusion resistance, and said second film portion has said second diffusion resistance.

17. The insulation packet according to claim 13, wherein said second diffusion resistance is high enough to prevent water vapor from diffusing through said film inwardly into said insulation packet, while said first diffusion resistance is low enough to allow water vapor to diffuse through said film outwardly out of said insulation packet.

18. The insulation packet according to claim 17, wherein at least a portion of said film uniformly has both said first diffusion resistance and said second diffusion resistance.

19. The insulation packet according to claim 13, wherein at least a portion of said film uniformly has both said first diffusion resistance and said second diffusion resistance.

20. The insulation packet according to claim 13, wherein said insulation material is a flossy fleece of said insulation material.

21. The insulation packet according to claim 20, wherein said insulation material consists of polyphenylene sulfide.

22. The insulation packet according to claim 13, wherein said film includes a first film portion having said first diffusion resistance and a first film thickness, and a second film portion having said second diffusion resistance and a second film thickness, and wherein said second film thickness is greater than said first film thickness.

23. In an air vehicle including an outer skin, an inner trim component that is arranged spaced from said outer skin with an interspace therebetween and that bounds an interior cabin therein, and an insulation arrangement including an insulation packet disposed in said interspace;
an improvement of said insulation arrangement,
wherein said insulation packet comprises an insulation material and a gas permeable film that completely surrounds and encases said insulation material,
wherein said film has an inner film surface that faces inwardly in said insulation packet toward said insulation material and an outer film surface that is opposite said inner film surface and that faces outwardly from said insulation packet, and
wherein said film has a first diffusion resistance with respect to gas diffusion through said film from said inner film surface to said outer film surface outwardly out of said insulation packet and a second diffusion resistance with respect to gas diffusion through said film from said outer film surface to said inner film surface inwardly into said insulation packet, wherein said second diffusion resistance is different from said first diffusion resistance.

24. The improvement of the insulation arrangement in the air vehicle according to claim 23, wherein said second diffusion resistance is greater than said first diffusion resistance.

25. The improvement of the insulation arrangement in the air vehicle according to claim 23, wherein said film includes a first film section and a second film section that are joined with each other along joined edges thereof, wherein said first film section and said second film section respectively have different film properties.

26. The improvement of the insulation arrangement in the air vehicle according to claim 25, wherein said first film section and said second film section respectively consist of different film materials.

27. The improvement of the insulation arrangement in the air vehicle according to claim 25, wherein said first film section has a smaller thickness than said second film section.

28. The improvement of the insulation arrangement in the air vehicle according to claim 27, wherein said insulation packet has said first and second film sections on opposite sides thereof and is oriented with said first film section toward said outer skin and said second film section toward said inner trim component.

29. The improvement of the insulation arrangement in the air vehicle according to claim 25, wherein said insulation packet has said first and second film sections on opposite sides thereof and is oriented with said first film section toward said outer skin and said second film section toward said inner trim component, said first film section consists of a first film material having a first gas diffusion resistance coefficient in a first diffusion direction through said first film section from said inner film surface to said outer film surface thereof, said second film section consists of a second film material having a second gas diffusion resistance coefficient in a second diffusion direction through said second film section from said outer film surface to said inner film surface thereof, and said second gas diffusion resistance coefficient is greater than said first gas diffusion resistance coefficient.

30. The improvement of the insulation arrangement in the air vehicle according to claim 23, further comprising a stringer arranged in said interspace, wherein said insulation packet is arranged adjacent to said stringer so as to form an air gap between said insulation packet and said outer skin.

31. The improvement of the insulation arrangement in the air vehicle according to claim 30, further comprising spacer members arranged between said stringer and said insulation packet or between said stringer and said outer skin.

32. The improvement of the insulation arrangement in the air vehicle according to claim 23, wherein said inner trim component has openings therethrough, which allow air containing water vapor to pass from said interior cabin through said openings into said interspace and to contact a surface of said film facing toward said inner trim component.

33. The improvement of the insulation arrangement in the air vehicle according to claim 23, wherein said air vehicle further includes an air conditioning device that provides conditioned air, said insulation packet is spaced away from said inner trim component to form an inner air space therebetween, and said conditioned air is admitted to said inner air space to flow therethrough.

34. The improvement of the insulation arrangement in the air vehicle according to claim 23, wherein said film consists of a synthetic plastic, said insulation material consists of polyphenylene sulfide, and said insulation packet has a cross-sectional contour fitted to a contour of said outer skin.

35. The improvement of the insulation arrangement in the air vehicle according to claim 23, wherein said film includes a first film section on a side of said insulation packet oriented toward said outer skin and a second film section on a side of said insulation packet oriented toward said inner trim component, said second film section is a water vapor barrier that hinders water vapor from permeating into said insulation packet through said second film section, and said first film section is a water vapor permeable film that allows water vapor to permeate out of said insulation packet through said first film section.

36. In an aircraft including an outer skin, an inner trim component that is arranged spaced from said outer skin with an interspace therebetween and that bounds an interior cabin therein, and an insulation arrangement including an insulation packet disposed in said interspace;
an improvement of said insulation arrangement, wherein
said insulation packet comprises an insulation material and a gas permeable film that completely surrounds and encases said insulation material,
said film includes a first film section on a side of said insulation packet oriented toward said outer skin and a second film section on a side of said insulation packet oriented toward said inner trim component,
said second film section is a water vapor barrier that hinders water vapor from permeating into said insulation packet through said second film section, and
said first film section is a water vapor permeable film that allows water vapor to permeate out of said insulation packet through said first film section.

37. The improvement of the insulation arrangement in the aircraft according to claim 36, wherein said first film section has a greater porosity than said second film section.

38. The improvement of the insulation arrangement in the aircraft according to claim 36, wherein said first film section has a more water permeable character and said second film section has a more water vapor impermeable character relative to each other.

39. The improvement of the insulation arrangement in the aircraft according to claim 36, wherein said first and second film sections both respectively have a temperature-dependent water vapor permeability characteristic that is more permeable by water vapor at a higher temperature and less permeable by water vapor at a lower temperature.
